(19) United States
(12) Patent Application Publication
(10) Pub. No.: US 2010/0105795 A1
(43) Pub. Date: Apr. 29, 2010

(54) Liquid Stable Thiol-Acrylate/Vinyl Ether Compositions

(75) Inventors: Eerik Maandi, Rocky Hill, CT (US); Edwin Perez, Newington, CT (US); John G. Woods, Farmington, CT (US); Joel D. Schall, Hamden, CT (US); Seamus Grant, Dublin (IE)

Correspondence Address: Loctite Corporation, One Henkel Way, Rocky Hill, CT, 06067, US

(73) Assignee: HENKEL CORPORATION, Rocky Hill, CT (US)

(21) Appl. No.: 11/814,536

(22) PCT Filed: Nov. 11, 2005
(86) PCT No.: PCT/US05/41053

§ 371 Date: Oct. 10, 2008

Related U.S. Application Data
(60) Provisional application No. 60/648,917, filed on Feb. 1, 2005.

(51) Int. Cl. C08L 75/00; C08G 75/00; C08F 2/46; C08G 18/00; C08G 18/63

(52) U.S. Cl. 522/48; 528/364; 528/360; 522/180; 525/453; 525/124

(57) ABSTRACT

The present invention relates to liquid stable thiol-acrylate and thiol-vinyl ether compositions. More particularly, in accordance with some embodiments, the compositions may include a (meth)acrylate, a thiol component, an organic acid stabilizer, and a curing initiator. In other embodiments, the compositions may include a curable component selected from a (meth)acrylate, vinyl ether and/or alkenyl ether, a reactive diluent having vinyl ether and acrylate functionality, a thiol component and a stabilizer selected from an organic acid, a hemiacetal ester derivative of an organic acid and/or a phenol acetal.

### BACKGROUND OF THE INVENTION

1. Field of the Invention

The present invention relates to liquid stable thiol-acrylate and thiol-vinyl ether compositions. More particularly, the present invention relates to compositions containing an acrylate or vinyl, or alkenyl, ether resin and a thiol component, which enhances the surface cure properties of the composition. The compositions also include a stabilizer, such as an organic acid, to promote the stability of the composition and adhesion without adversely affecting surface cure properties.

2. Brief Description of Related Technology

Thiol-ene compositions have been developed by crosslinking polyenes with polythiols. Typically, the polyenes are bicyclic ene compounds. The polythiols are added in stoichiometric amounts. Such thiol-ene compositions can be cured by photopolymerization for a variety of uses, such as coatings, adhesives, sealants, and the like. Thiol-ene compositions are illustrated by way of example in U.S. Pat. Nos. 4,808,638, 5,028,661, 5,371,181, 5,399,624 and 5,459,173, the contents all of which are incorporated herein by reference in their entirety. The addition of thiols, however, makes it difficult to stabilize these compositions, especially to attain long-term shelf-life. Premature polymerization between the polyene and the polythiol typically is undesirable.

Also known are curable epoxy-based systems including polythiol compounds. These compositions include epoxy compounds, polythiol compounds, and additionally include latent hardeners to effect the heat cure of the epoxy resin. Such epoxy-thiol systems are used as sealants, adhesives, and the like, particularly for applications in the electronics industry. Solid organic acids are added to one or two-part epoxy-thiol systems to enhance the shelf-stability thereof. Such epoxy-based systems are illustrated by way of example in U.S. Pat. No. 6,653,371 to Burns et al., which is incorporated herein by reference.

The incorporation of organic acid stabilizers to promote the liquid stability, i.e., shelf-life, and adhesion of thiol-acrylate compositions, as well as thiol-vinyl ether compositions, was not known prior to the present invention.

### SUMMARY OF THE INVENTION

The present invention provides compositions containing (meth)acrylate terminated or vinyl, or alkenyl, ether terminated resins. The compositions also include a thiol component, which enhances surface cure of the composition, as well as a stabilizer to promote the liquid stability and adhesion thereof. Desirably, the compositions further include a reactive diluent and a curing initiator.

In one aspect of the present invention, there is provided a composition including: at least one (meth)acrylate; at least one thiol component; at least one organic acid present in a stabilizing amount; and at least one curing initiator.

In another aspect of the present invention, there is provided a composition including: a polyether urethane triacrylate; a thiol component present in amounts of about 0.5% to about 5% by weight of the composition; and an organic acid present in amounts of about 0.1% to about 5% by weight of the composition.

In another aspect of the present invention, there is provided a composition including: at least one (meth)acrylate; pentaerythritol tetrakis(3-mercaptopropionate); and an organic acid present in amounts of about 0.1% to about 5% by weight of the composition.

In another aspect of the present invention, there is provided a method of improving the liquid stability of a composition, including the steps of: (a) providing a composition containing: at least one (meth)acrylate; at least one thiol component present in an amount sufficient to effect surface cure; and at least one curing initiator; and (b) adding at least one organic acid in a stabilizing amount to the composition to promote the liquid stability thereof.

In yet another aspect of the present invention, there is provided a composition including: at least one curable component selected from a (meth)acrylate, vinyl ether, alkenyl ether and combinations thereof; a reactive diluent having at least one vinyl ether or 1-alkenyl ether group and at least one (meth)acrylate group; a thiol component; and a stabilizer selected from an organic acid, a hemiacetal ester derivative of an organic acid, a phenol acetal and combinations thereof.

In still another aspect of the present invention, there is provided a method of improving the liquid stability of a composition; including the steps of: (a) providing a composition including: (i) at least one curable component selected from a (meth)acrylate, vinyl ether, alkenyl ether and combinations thereof; (ii) a reactive diluent having at least one vinyl ether or 1-alkenyl ether group and at least one (meth)acrylate group; (iii) at least one thiol component present in an amount sufficient to effect surface cure; and (iv) at least one curing initiator; and (b) adding at least one stabilizer selected from an organic acid, a hemiacetal ester derivative of an organic acid, a phenol acetal and combinations thereof to the composition to promote the liquid stability thereof.

### DETAILED DESCRIPTION OF THE INVENTION

The present invention is directed to (meth)acrylate or vinyl, or alkenyl, ether resin compositions including a thiol component for improved surface cure and adhesion. More specifically, thiols may promote tack-free surface cure upon irradiation, particularly by visible light. As described above, however, the addition of thiols to such compositions may adversely affect stability. Accordingly, a stabilizer, such as an organic acid, may be included to promote the liquid stability of the composition. The stabilizer promotes liquid stability by preventing premature polymerization and, thereby, enhances the shelf-life of the composition. Desirably, addition of a stabilizer maintains liquid stability for more than about one week. Stabilizers also may present loss of surface cure activity over time.

The term “cure” or “curing,” as used herein, refers to a change in state, condition, and/or structure in a material that is usually, but not necessarily, induced by at least one variable, such as time, temperature, moisture, radiation, presence and quantity in such material of a curing catalyst or accelerator, or the like. The terms cover partial as well as complete curing.

The compositions of the present invention may include a curable component, such as a (meth)acrylate, vinyl ether or alkenyl ether, a thiol component and a stabilizer. The stabilizer may be an organic acid, a hemiacetal ester derivative of an organic acid and/or a phenol acetal. The compositions also may include components such as curing initiator(s) and reactive diluents, among others.

More specifically, some embodiments of the present invention are directed to compositions including a (meth)acrylate, a thiol component and a stabilizer, which is an organic acid. Desirably, the compositions further may include a curing initiator and a reactive diluent.

The (meth)acrylate contained in these compositions may be any conventional (meth)acrylate known to those skilled in the art. For example, the (meth)acrylate may be a tri-functional urethane acrylate oligomer, more desirably an aliphatic polyether urethane triacrylate. An example of a suitable (meth)acrylate is BR-990 (commercially available from Bomar Specialties, Co), which is a urethane triacrylate oligomer having a polyether backbone.

In some embodiments, the (meth)acrylate may be present in amounts of about 20% to about 80% by weight of the composition. Desirably, the (meth)acrylate may be present in amounts of about 50% to about 70%, more desirably about 55% to about 65% by weight of the composition. In certain embodiments in which oligomeric or polymeric thiol components are included, such as, for example, thiols having a molecular weight of about 1,000 to about 10,000, the (meth)acrylate may be present in lower amounts to allow for a higher concentration of thiol. More specifically, the (meth)acrylate may be present in amounts of about 5% to about 40% by weight of the composition.

The compositions of the present invention also may include a thiol component. Thiols may improve the adhesion and surface cure properties of the composition. In addition, in compositions including cationic initiators, thiols may provide the added benefit of reducing or eliminating scorching, i.e., surface charring and/or discoloration during cure.

Examples of suitable thiols include, but are not limited to: pentaerythritol tetrakis(3-mercaptopropionate), ethoxylated pentaerythritol tetrakis(3-mercaptopropionate), pentaerythritol tetrakis(2-mercaptoacetate), tripentaerythritol octakis(thioglycollate), dipentaerythritol hexakis(thioglycollate) and mercapto-propionates and acetates prepared by oligomerization techniques, such as those described in Example 12 of U.S. Pat. No. 5,459,175, which is incorporated by reference herein in its entirety. More specifically, such oligomers may be prepared by the addition reaction of a multifunctional mercaptopropionate or mercaptoacetate with a stoichiometric deficiency of a dialkene or multi-alkenyl monomer that is not subject to extensive homopolymerization during the thiol-ene addition reaction.

When incorporated into the compositions of the present invention, thiols may be present in amounts of about 0.25% to about 10% by weight of the composition, more desirably about 0.5% to about 5% by weight. In certain embodiments in which oligomeric or polymeric thiols are included, such as, for example, thiols having a molecular weight of about 1,000 to about 10,000, the concentration of the thiol component may be increased to provide an effective amount of thiol. More specifically, the thiol component may be present in amounts of up to about 30% by weight of the composition.

As described above, the thiol component may provide improved surface cure properties, but affects the stability of the compositions. It is desirable, therefore, to incorporate a stabilizer to promote the liquid stability of the compositions, i.e., prevent premature polymerization. More specifically, it is desirable to maintain the liquid stability of the compositions for more than about one week at 50° C.-80° C., more desirably about four weeks at about 50° C., thereby conferring a desirable shelf-life to the compositions while also maintaining the surface curing and adhesion properties. Additionally, an acid stabilizer may prevent loss of surface cure activity over time, i.e., after heat aging.

In some embodiments, an organic acid may be included as a stabilizer. Desirably, the organic acid has a pKₐ of about 1.5 to about 11.5. Examples of suitable organic acids include, but are not limited to: (meth)acrylic acid; maleic acid; fumaric acid; cinnamic acid; cyanoacetic acid; barbituric acid; 1,3-dimethylbarbituric acid; malonic acid; methylmalonic acid; mono-ethyl malonate; 2-acetylcyclohexanone; ethyl cyanoacetate; acetylacetone; acetoacetic acid; ethyl acetoacetate; dihydroresorcinol; 1,3-diketones; 1,3,5-triketones; β-ketoesters, such as β-acetoacetates; ascorbic acid; phenolic compounds; pyruvic acid; mono-ethyl fumarate; mono-butyl maleate; mono-2-(methacryloyloxy)ethyl maleate; and combinations thereof.

The acid may be present in a stabilizing amount, which may be about 0.1% to about 20% by weight of the composition. Desirably, the acid is present in amounts of about 0.5% to about 15%, more desirably about 1% to about 5% by weight of the composition.

The compositions also may include one or more curing initiators. Desirably, the compositions cure upon exposure to visible light, i.e., irradiation at about 400-700 nm, desirably about 400-500 nm. The compositions also may be cured by exposure to other energy sources, including, but not limited to, UV irradiation and heat. Accordingly, the curing initiator(s) incorporated into the compositions of the present invention may be a UV photoinitiator, visible light photoinitiator, thermal initiator, redox initiator or any combination thereof.

Desirably, the curing initiator(s) is a visible light photoinitiator. Examples of suitable visible light photoinitiators include, but are not limited to: camphorquinone; two-component initiators including a dye and electron donor; three-component initiators including a dye, electron donor and oxidant; and combinations thereof.

Suitable dyes include, but are not limited to: camphorquinone, 5,7-diiodo-3-butoxy-6-fluorone, rose bengal, riboflavin, eosin Y, benzil, fluorone dyes, benzil derivatives, ketocoumarins; acridine dyes; benzoflavin; and combinations thereof.

Suitable electron donors include, but are not limited to: methyldiethanolamine, dimethyl-p-toluidine, N,N-dimethylaminoethyl methacrylate, ethyl 4-dimethylaminobenzoate and combinations thereof.

Suitable oxidants include, but are not limited to: bis(trichloromethyl)triazines, onium salts and combinations thereof. Examples of onium salts include sulfonium and iodonium salts.

Examples of suitable UV initiators include, but are not limited to: phosphine oxides; benzophenone and substituted benzophenones, acetophenone and substituted acetophenones, benzoin and its alkyl ethers and combinations thereof.

In addition to a UV photoinitiator, visible light photoinitiator, thermal initiator and/or a redox initiator, some embodiments also may include a cationic initiator. Cationic initiators include, but are not limited to, oxidants as provided above, such as diaryliodonium salts and dialkylphenacyl sulfonium salts, optionally with a sensitizing dye, such as the dyes provided above. The use of a cationic initiator in the absence of a sensitizing dye is described in U.S. Pat. No. 4,058,400, which is incorporated by reference herein in its entirety.

The curing initiator(s) may be present in amounts of about 0.01% to about 15% by weight of said composition, more desirably about 0.05% to about 5% by weight of the composition.

Additionally, the compositions may include a reactive diluent. A variety of reactive diluents may be employed, such as those having (meth)acrylate and/or vinyl ether functionality. In some embodiments, the reactive diluent is a “hybrid” diluent because it includes at least one vinyl ether or 1-alkenyl ether group and at least one (meth)acrylate group. For instance, the reactive diluent may be represented by the following formula (I):

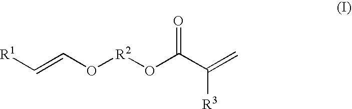

where R¹ is selected from hydrogen; aliphatic C₁₋₆ alkyl; and C₁₋₆ cycloalkyl;

R² is selected from C₂₋₂₀ alkylene; C₂₋₂₀ hydrocarbon diradical; and polyalkylene oxide; and

R³ is selected from hydrogen and methyl.

The reactive diluent may have a molecular weight of less than about 1500. Desirably, the molecular weight is less than about 750, more desirably less than about 500. The viscosity of the reactive diluent may be less than about 5000 cps at 25° C., more desirably less than about 2000 cps and even more desirably about 50-500 cps.

The mole ratio of ene groups, which are not acrylate, in the reactive diluent to the moles of the thiol component may be at least about 10:1 to about 525:1. Desirably, the ratio of non-acrylate ene groups to thiol is about 25:1 to about 35:1, and more desirably about 27:1 to about 33:1.

Examples of suitable reactive diluents include, but are not limited to: 2-(2′-vinyloxyethoxy)ethyl acrylate, 2-(2′-vinyloxyethoxy)ethyl methacrylate, 2-vinyloxyethyl acrylate, 2-vinyloxyethyl methacrylate, 2-(2′-prop-1-enyloxyethoxy)ethyl methacrylate, 2-(2′-prop-1-enyloxyethoxy)ethyl acrylate, and combinations thereof.

The reactive diluent may be present in amounts of about 10% to about 70% by weight of the composition, desirably about 20% to about 40% by weight of the composition.

More specifically, in some embodiments, the compositions of the present invention may include a polyether urethane triacrylate, a thiol component present in amounts of about 0.5% to about 5% by weight of the composition and an organic acid present in amounts of about 0.1% to about 5% by weight of the composition.

In other embodiments, the compositions may include at least one (meth)acrylate, pentaerythritol tetrakis(3-mercaptopropionate) and an organic acid present in amounts of about 0.1% to about 5% by weight of the composition.

The present invention also is directed to compositions including at least one curable component selected from (meth)acrylates, vinyl ethers and/or alkenyl ethers, a thiol component, a stabilizer, which may be an organic acid, a hemiacetal ester derivative of an organic acid and/or a phenol acetal, and a reactive diluent.

In such embodiments, the reactive diluent desirably is the hybrid diluent described above, which has both (meth)acrylate and vinyl ether, or alkenyl ether, functionality. The thiol component may be any of the thiols described above. These components may be present in the amounts described above.

The curable component may be a (meth)acrylate or a vinyl or alkenyl ether. Any conventional (meth)acrylate, vinyl ether or alkenyl ether resin may be employed. In some embodiments, the curable component may be a polyurethane oligomer or polyurethane block copolymer, which has (meth)acrylate, vinyl ether or alkenyl ether functionality.

More specifically, the curable component may be a polyurethane block copolymer having a backbone of alternating hard and soft segments and at least two ends. The ends each may be terminated with a vinyl ether, alkenyl ether or (meth)acrylate group. Such polyurethane block copolymers may be represented by the following general formula (II):

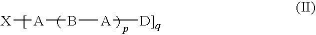

where A is a hard segment;

B is a divalent soft segment;

X is a q-valent soft segment;

D is a vinyl ether or (meth)acrylate group;

p is 0-10; and

q is 2-6.

In formula (II) above, A represents the hard segments. A may be the reaction product of a polyisocyanate and an aromatic, heterocyclic or cycloaliphatic polyol. Accordingly, A may be an aromatic, heterocyclic or cycloaliphatic segment derived from a polyisocyanate.

B and X, in formula (II) above, represent the soft segments. B and X may be a divalent and a multivalent group, respectively, derived from a polyether polyol, polyester polyol or hydrogenated hydrocarbon elastomer, such as polybutadiene.

As represented by D in formula (II), the polyurethane block copolymer may be terminated with vinyl ether groups or (meth)acrylate groups. Suitable vinyl ether compounds from which the vinyl ether terminal groups may be derived include hydroxy functional vinyl ethers. Examples of suitable compounds include, but are not limited to: 2-hydroxyethyl vinyl ether, 4-hydroxybutyl vinyl ether, cyclohexanedimethanol monovinyl ether, diethylene glycol monovinyl ether, 1,6-hexanediol monovinyl ether and 3-aminopropyl vinyl ether.

Alternatively, the vinyl ether terminal groups may be derived from an amino functional vinyl ether, in which case vinyl ether urea capped polyurethanes may be obtained.

Such polyurethane block copolymers are illustrated by way of example in co-pending application entitled “Vinyl Ether/Acrylate Block Resins, Compositions And Methods of Making Same” and filed on evendate herewith (Express Mail Label No. EV481316295US), which is incorporated by reference herein in its entirety.

Other suitable resins include those disclosed in U.S. Pat. Nos. 4,018,851, 4,295,909 and 4,309,526 to Baccei, and U.S. Pat. Nos. Re 33,211, 4,751,273, 4,775,732, 5,019,636 and 5,139,872 to Lapin et al., the contents all of which are incorporated by reference herein in their entirety. Combinations of any of the resins described above also may be incorporated into the compositions of the present invention.

The curable component may be present in amounts of about 20% to about 95% by weight of the composition. Desirably, the curable component is present in amounts of about 40% to about 70% by weight of the composition.

The stabilizer component employed in these embodiments may be an organic acid, a hemiacetal ester derivative of an organic acid and/or a phenol acetal. The organic acid may be any of the acids described above. Desirably, the organic acid has a pKₐ of about 1.5 to about 11.5. The organic acid may be present in the amounts described above.

The hemiacetal ester may be derived from an organic acid, such as, but not limited to: (meth)acrylic acid; β-carboxyethyl acrylate; maleic acid; fumaric acid; cinnamic acid; and cyanoacrylic acid. The hemiacetal ester provides enhanced adhesion properties to the compositions, as well. In particular, the incorporation of hemiacetal esters may promote adhesion to polycarbonates.

An example of a suitable hemiacetal ester is diacrylate hemiacetal ester, represented as:

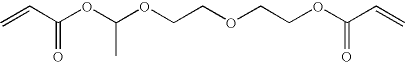

The hemiacetal ester may be present in amounts of about 0.5% to about 30% by weight of the composition. Desirably, the hemiacetal ester may be present in amounts of about 5% to about 20% by weight of the composition.

The phenol acetal may be prepared by reaction of a phenol with a vinyl ether. Examples of suitable phenols include, but are not limited to: phenol; 4-methylphenol; anisole; catechol; resorcinol; 1,4-hydroquinone; methyl ether hydroquinone; bisphenol A; diallyl bisphenol A; 2,2-biphenol; 1-naphthol; 2,6-dihydroxynaphthalene; and combinations thereof.

In accordance with the present invention, these compositions further may include one or more curing initiators and, optionally, cationic initiator(s), as described above. Desirably, the compositions cure upon exposure to visible light and, thereby, include at least one visible light photoinitiator. Such initiators may be employed in the amounts described above.

Any of the compositions described herein also may contain optional additives including free radical scavengers, such as, but not limited to, 4-methoxy phenol, hydroquinone, 1,4-naphthoquinone and/or 2,6-di-tert-butyl-4-methylphenol, additional monomers, such as, but not limited to, N,N-dimethylacrylamide (N,N-DMAA) and partially acrylated bisphenol A epoxy (EBECRYL 3605), stabilizers, inhibitors, oxygen scavenging agents, fillers, dyes, colors, pigments, additional adhesion promoters, wetting agents, odor masks, plasticizers, toughening agents, reinforcing agents, fluorescing agents, rheological control agents and combinations thereof.

The present invention also relates to methods of using the compositions described above. In general, a stabilizer may be added to the thiol-resin compositions to promote the liquid stability and surface cure retention thereof. In some embodiments, a composition including a (meth)acrylate, a thiol component and curing initiator(s) is provided. An organic acid stabilizer may be added to the composition to promote the liquid stability thereof. Addition of the organic acid assists in preventing premature polymerization and loss of surface cure, thereby improving the shelf-life of the composition.

In other embodiments, a composition including: a curable component, which is a (meth)acrylate, vinyl ether and/or alkenyl ether; hybrid reactive diluent; thiol; and curing initiator(s) is provided. A stabilizer may be added to the composition to promote the liquid stability and surface cure retention thereof. The stabilizer may be an organic acid, a hemiacetal ester derivative of an organic acid and/or a phenol acetal. Addition of the stabilizer assists in preventing premature polymerization and loss of surface cure, thereby improving the shelf-life of the composition.

### EXAMPLES

### Example 1

Compositions containing the following components were prepared using a DAC 400 FVZ speed mixer for five minutes: urethane triacrylate oligomer (“BR-990”) (from Bomar Specialty Chemicals); 2-(2′-vinyloxyethoxy)ethyl acrylate (“FX-VEEA”) (as a reactive diluent); camphorquinone (as a visible light photoinitiator); and pentaerythritol tetrakis(3-mercaptopropionate) (“PETMP”). These components were included in the amounts indicated in Table 1 below (for Compositions A-E). As shown in Table 1, a different organic acid stabilizer was included in each of Compositions B-D, but not in Composition A (comparative). The following stabilizers were employed: acrylic acid; mono-2-(methacryloyloxy)ethyl maleate; and 4-methoxy phenol.

TABLE 1

| | Composition | | | |
|---|---|---|---|---|
| Component | A (comparative) | B | C | D |
| BR-990 | 66.85 | 63.51 | 63.51 | 66.82 |
| FX-VEEA | 30 | 28.5 | 28.5 | 29.99 |
| Camphorquinone | 0.53 | 0.5 | 0.5 | 0.53 |
| PETMP | 2.62 | 2.49 | 2.49 | 2.62 |
| Acrylic acid | | 5 | | |
| Mono-2- | | | 5 | |
| (methacryloyloxy)ethyl | | | | |
| maleate | | | | |
| 4-methoxy phenol | | | | 0.05 |

The compositions were tested for stability, surface tack and block shear strength. The results of these tests are shown in Tables 2, 3 and 4 below, respectively.

Stability was tested by pouring 10 grams of each composition into a 4 dram vial. The compositions then were visually inspected for the presence of polymer, i.e., gelation. The absence of gelation indicated that the compositions were stable. Measurement at four weeks and 50° C. is generally understood to correspond to about one year at room temperature shelf-life.

Surface tack was rated on a scale of 1 to 5, with 5 being tack-free; a description of the ratings is as follows:
1. Completely uncured
2. Gelled bulk, uncured surface
3. Cured bulk; surface leaves residue on glove when contacted and typically retains all silicon carbide grit (“SiC”) when dusted
4. Surface leaves no residue but feels sticky and typically retains 50-60% SiC
5. Surface is dry, tack-free, and retains ≦10% SiC

Surface cure was typically evaluated on samples that had been irradiated for 40 seconds with a 470 nm “Demetron” LED at a source-to-sample distance of 10 mm.

Block shear adhesion was measured using polycarbonate specimens (1×1×¼″); the specimens were assembled with no induced gap and with a ½″ overlap. Since the usual Demetron light source has a diameter of only 1 cm, two Demetrons were placed side by side to achieve cure of the ½×1″ bond line. Alternatively, a conveyorized array system or a 450 nm LED array could be used; due to its more uniform intensity, bonds cured with the array typically displayed higher adhesive strength. Polycarbonate block shear specimens were assembled and cured with four passes through a conveyorized 470 nm LED source; each pass exposed the specimens to approximately 30 seconds of light at a maximum intensity of 85 mW/cm². The resulting block shear adhesion was measured according to ASTM D4501, “Shear Strength of Adhesive Bonds between Rigid Substrates by the Block-Shear Method,” which is incorporated by reference herein, using a 20 kN load cell. Adhesive strength was measured in units of pounds per square inch of compressive pressure needed to break the bond.

TABLE 2
Stability at 50° C. and 80° C.

Composition

| | A | B | C | D |
|---|---|---|---|---|
| # of Days (50° C.) | | | | |
| 1 | NG¹ | OK | OK | OK |
| 17 | | OK | OK | OK |
| 23 | | OK | OK | OK |
| 30 | | OK | OK | OK |
| # of Days (80° C.) | | | | |
| 1 | NG | OK | OK | OK |
| 17 | | OK | OK | OK |
| 23 | | OK | NG | OK |
| 30 | | OK | NG | OK |

¹NG = Not Good (polymerized)

TABLE 3
Surface Cure

Composition

| # of Weeks | A | B | C | D |
|---|---|---|---|---|
| Fresh | 4 | 4+ | 4+ | 4+ |
| 1 week (50° C.) | ND | 4 | 4 | 4 |
| 1 week (80° C.) | ND | 4 | 4 | 4 |
| 2 week (50° C.) | ND | 4 | 4 | 4 |
| 2 week (80° C.) | ND | 4 | 4 | 4 |
| 4 week (50° C.) | ND | 4 | 4 | 4 |
| 4 week (80° C.) | ND | 3.5 | ND | 3 |

¹ND = Not Done

TABLE 4
Block Shear Strength

Composition

| # of Weeks | A | B | C | D |
|---|---|---|---|---|
| Fresh | 854 | 664 | 405 | 527 |
| 1 week at 50° C. | ND | 984 | 975 | 651 |
| 1 week at 80° C. | ND | 2483 | 3634 | 1063 |
| 2 week at 50° C. | ND | 1211 | 1256 | 391 |
| 2 week at 80° C. | ND | 3463 | 3720 | 1044 |
| 4 week at 50° C. | ND | 2192 | 2487 | 436 |
| 4 week at 80° C. | ND | 3125 | ND | 2378 |

### Example 2

A diacrylate hemi acetal ester for use as a stabilizer was prepared in accordance with the following.

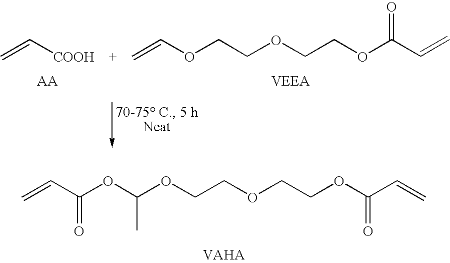

2-(2′-vinyloxyethoxy)ethyl acrylate (“VEEA”) (18.605 g; 0.1 moles) was placed in a 50 mL reaction flask equipped with magnetic stirrer, heating mantel, thermocouple and pressure compensating liquid addition funnel. The monomer was heated to 70° C. and acrylic acid (“AA”) (7.218 g; 0.1 moles) was added dropwise over 20 minutes, during which the mixture was stirred and heated at 70-75° C. Heating and stirring were continued for an additional 5 hours after which time the mixture was cooled to yield the hemi acetal acrylate (“VAHA”) as a faintly yellow colored oil in quantitative yield. The structure of the product was confirmed by infrared (IR) and proton magnetic resonance spectroscopy (1H NMR).

As the reaction proceeded, the mid IR absorbance band at about 3200 cm⁻¹, due to the hydroxyl group of the carboxylic acid, diminished and was completely absent in the final product. In addition, the carbonyl group absorbance due to the acid at 1702 cm⁻¹ had completely disappeared and a more intense absorption peak at 1720 cm⁻¹ was observed. This band is attributed to the carbonyl of ester group and its increasing intensity is indicative of additional ester formation. In the near IR spectrum of the starting VEEA, the first overtone absorption bands due to the double bonds of the vinyl ether and acrylate groups are observed at 6186 and 6164 cm⁻¹ respectively. In the reaction product, the band due to the vinyl ether component is completely absent and the spectrum shows just one double bond absorbance at 6164 cm⁻¹ due to acrylate. These analyses indicate that both carboxylic acid and vinyl ether groups are consumed in the reaction and that acrylate groups remain unreacted.

The ¹H NMR spectrum (300 MHz; CDCl₃) confirms the reaction of vinyl ether groups, i.e. loss of signals at δ=6.45, 4.03 and 4.20 and formation of hemiacetal ester with characteristic signal at 6.05 due to H atom located on carbon between two oxygen atoms of the acetal group. The spectrum also indicates the presence of two non-equivalent acrylate groups with multiplet signals at δ 5.85, 6.05 and 6.45 (6H); δ 4.30, m, [—C(O)O—CH₂ (2H)]; δ 3.80, m, [OCH2 (6H)]; and δ 1.45, d, [CH₃-(3H)]. The structure of the product is thus confirmed as the diacrylate hemi acetal ester as indicated above for VAHA.

### Example 3

The following composition was prepared on a 10 g scale and mixed in a DAC 400 FVZ speed mixer: 0.50 wt % camphorquinone, 28.46 wt % FX-VEEA, 5.03 wt % acrylic acid, 63.36 wt % BR-990, and 2.65 wt % PETMP.

Polycarbonate block shear specimens were assembled and cured with four passes through a conveyorized 470 nm LED source; each pass exposed the specimens to approximately 30 seconds of light at a maximum intensity of 85 mW/cm². The resulting block shear adhesion was measured according to ASTM D4501, referred to above, using a 20 kN load cell. The average adhesion of five specimens was 550±196 psi.

### Example 4

The following composition was prepared on a 10 g scale and mixed in a DAC 400 FVZ speed mixer: 0.49 wt % camphorquinone, 15.54 wt % FX-VEEA, 18.03 wt % VAHA (from Example 2), 63.31 wt % BR-990 and 2.63 wt % PETMP. This composition was designed to contain an equimolar amount of “acid” (in the form of the VAHA adduct) and FX-VEEA as the formulation in Example 3.

Polycarbonate block shear specimens were assembled and cured as in Example 3. The resulting average adhesion (5 specimens) was 1154±170 psi.

A ¼ inch diameter sample spot of the experimental composition was irradiated for 40 seconds with a 470 nm LEI) source at an intensity of 100 mW/cm²; the composition was found to give a completely tack-free surface under these conditions.

The composition was stored in the dark in an oven at 50° C.; samples were removed periodically and evaluated for surface cure and adhesion. Surface cure samples were prepared and cured as described above; adhesion testing was performed as described above. Results are given in Table 5 below.

TABLE 5

| Time at 50° C. | Surface | Adhesion (psi) |
|---|---|---|
| 0 (fresh) | tack-free | 1154 ± 170 |
| 6 days | tack-free | 1374 ± 237 |
| 14 days | tack-free | 1640 ± 355 |
| 29 days | tack-free | 2834 ± 424 |

### Comparative Example 5

The following composition was prepared on a 10 g scale and mixed in a DAC 400 FVZ speed mixer: 0.49 wt % camphorquinone, 19.67 wt % FX-VEEA, 5.06 wt % trimethylolpropane triacrylate (“TMPTA”), 2.18 wt % PETMP, 25.09 wt % partially acrylated bisphenol A epoxy (EBECRYL 3605) and 47.52 wt % hydroxyethyl acrylate-capped block resin (resin contains 17% by weight FX-VEEA). An acid stabilizer was not included in this composition.

The fresh composition provided a tack-free surface when irradiated for 5 minutes with 450 nm LED array (intensity ˜17 mW/cm²; dose ˜5.1 J/cm²). After 10 days' dark storage at 50° C., the surface no longer cured tack-free when irradiated under the same conditions.

### Example 6

A composition as in Comparative Example 5 was prepared, except that it included an acid stabilizer. More specifically, the following composition was prepared on a 10 g scale and mixed in a DAC 400 FVZ speed mixer: 0.50 wt % camphorquinone, 19.89 wt % FX-VEEA, 5.01 wt % TMPTA, 2.28 wt % PETMP, 25.10 wt % Ebecryl 3605, 46.73 wt % hydroxyethyl acrylate-capped block resin and 0.49 wt % 1,3-dimethylbarbituric acid (“DMBA”) (as an acid stabilizer).

The fresh composition provided a tack-free surface when irradiated for 40 seconds with a 470 nm LED (intensity ˜100 mW/cm²; dose ˜4 J/cm²). An aged composition still provided a tack-free surface after 18 days at 50° C. (an improvement of at least 8 days relative to Comparative Example 5).

### Comparative Example 7

The following composition was prepared on a 10 g scale and mixed in a DAC 400 FVZ speed mixer: 0.49 wt % camphorquinone, 20.17 wt % FX-VEEA, 5.06 wt % TMPTA, 2.23 wt % pentaerythritol-tetrakis(2-mercaptoacetate) (“PETMA”), 25.01 wt % Ebecryl 3605, 47.03 wt % hydroxyethyl acrylate-capped block resin. An acid stabilizer was not included in this composition.

The fresh composition provided good surface cure when irradiated for 40 seconds with 470 nm LED (100 mW/cm² intensity). After four days at 50° C., the surface remained tacky when irradiated under the same conditions.

### Example 8

A composition as in Comparative Example 7 was prepared, except that it included an acid stabilizer. More specifically, the following composition was prepared on a 10 g scale and mixed in a DAC 400 FVZ speed mixer: 0.45 wt % camphorquinone, 19.05 wt % FX-VEEA, 11.72 wt % TMPTA (excess used to help dissolve acid), 2.05 wt % PETMA, 22.98 wt % Ebecryl 3605, 43.21 wt % hydroxyethyl acrylate-capped block resin and 0.54 wt % barbituric acid (as an acid stabilizer).

The fresh composition cured tack-free when irradiated for 40 seconds at 100 mW/cm². The aged composition still cured tack-free after 28 days' dark storage at 50° C. (an improvement of ≧24 days relative to Comparative Example 7).

### Comparative Example 9

The following composition was prepared on a 10 g scale and mixed in a DAC 400 FVZ speed mixer: 0.50 wt % camphorquinone, 20.06 wt % FX-VEEA, 5.12 wt % TMPTA, 2.20 wt % clay-treated PETMP, 24.97 wt % Ebecryl 3605, 47.15 wt % hydroxyethyl acrylate-capped block resin. An acid stabilizer was not included in this composition. Clay treatment removes any acid stabilizer present in commercial PETMP.

The fresh composition cured tack-free when irradiated for 40 sec at 100 mW/cm². After aging for 7 days at 50° C., the composition remained tacky when irradiated under the same conditions.

### Example 10

A composition as in Comparative Example 9 was prepared, except that it included an acid stabilizer. More specifically, the following composition was prepared on a 10 g scale and mixed in a DAC 400 FVZ speed mixer: 0.51 wt % camphorquinone, 19.94 wt % FX-VEEA, 5.12 wt % TMPTA, 2.14 wt % clay-treated PETMP, 25.12 wt % Ebecryl 3605, 46.65 wt % hydroxyethyl acrylate-capped block resin and 0.52 wt % DMBA (as an acid stabilizer).

The composition retained good surface cure (i.e., it cured tack-free when irradiated for 40 sec at 100 mW/cm²) after storage of >17 days at 50° C. (an improvement of ≧10 days relative to Comparative Example 9).

### Example 11

The following composition was prepared on a 10 g scale and mixed in a DAC 400 FVZ speed mixer:

TABLE 6

| Component | Weight % (range) |
|---|---|
| FX-VEEA | 45-55 |
| Hydroxyethyl acrylate-capped block | 20-30 |
| resin | |
| Ebecryl 3605 | 20-30 |
| PETMP | 0.5-5 |
| Barbituric acid | 0.1-1 |
| Camphorquinone | 0.5 |

A second composition was prepared with the same components and quantities, except that 0.1-1 wt % DMBA was used in place of the barbituric acid.

The fresh compositions cured tack-free when irradiated for 40 seconds at 100 mW/cm². The aged compositions still cured tack-free after 28 days' storage at 50° C.

1. A composition comprising:
(a) at least one (meth)acrylate;
(b) at least one thiol component;
(c) at least one organic acid present in a stabilizing amount; and
(d) at least one curing initiator.

2. The composition of claim 1, further comprising at least one reactive diluent.

3. The composition of claim 2, wherein said reactive diluent comprises one or more non-acrylate ene groups and the molar ratio of said ene groups to said thiol component is at least about 10:1.

4. The composition of claim 3, wherein the molar ratio of said ene groups to said thiol component is about 25:1 to about 35:1.

5. The composition of claim 2, wherein said at least one reactive diluent comprises 2-(2′-vinyloxyethoxy)ethyl acrylate.

6. The composition of claim 2, wherein said at least one reactive diluent is present in amounts of about 10% to about 70% by weight of said composition.

7. The composition of claim 1, wherein said thiol component is present in amounts of about 0.25% to about 10% by weight of said composition.

8. (canceled)

9. The composition according to claim 1, wherein said thiol component is selected from the group consisting of pentaerythritol tetrakis(3-mercaptopropionate), ethoxylated pentaerythritol tetrakis(3-mercaptopropionate), pentaerythritol tetrakis(2-mercaptoacetate), tripentaerythritol octakis(thioglycollate), dipentaerythritol hexakis(thioglycollate), mercapto-propionate and acetate functional oligomers and combinations thereof.

10. The composition according to claim 1, wherein said organic acid is present in amounts of about 0.1% to about 20% by weight of said composition.

11. The composition according to claim 1, wherein said organic acid is selected from the group consisting of: (meth)acrylic acid; maleic acid; fumaric acid; cinnamic acid; cyanoacetic acid; barbituric acid; 1,3-dimethylbarbituric acid; malonic acid; methylmalonic acid; mono-ethyl malonate; 2-acetylcyclohexanone; ethyl cyanoacetate; acetylacetone; acetoacetic acid; ethyl acetoacetate; dihydroresorcinol; 1,3-diketones; 1,3,5-triketones; β-ketoesters; ascorbic acid; phenolic compounds; pyruvic acid; mono-ethyl fumarate; mono-butyl maleate; mono-2-(methacryloyloxy)ethyl maleate; and combinations thereof.

12. The composition of claim 1, wherein said at least one (meth)acrylate comprises a tri-functional urethane acrylate oligomer.

13. The composition of claim 12, wherein said tri-functional urethane acrylate oligomer comprises an aliphatic polyether urethane triacrylate.

14. The composition of claim 1, wherein said at least one (meth)acrylate is present in amounts of about 20% to about 80% by weight of said composition.

15. The composition of claim 1, wherein said curing initiator comprises a visible light photoinitiator.

16. The composition of claim 15, wherein said visible light photoinitiator is selected from the group consisting of: camphorquinone; two-component initiators comprising a dye and electron donor; three-component initiators comprising a dye, electron donor and oxidant; and combinations thereof.

17. The composition of claim 15, wherein said visible light photoinitiator is present in amounts of about 0.01% to about 15% by weight of said composition.

18. The composition of claim 1, further comprising a free radical scavenger.

19. (canceled)

20. A composition comprising:
(a) a polyether urethane triacrylate;
(b) a thiol component present in amounts of about 0.5% to about 5% by weight of said composition; and
(c) an organic acid present in amounts of about 0.1% to about 5% by weight of said composition.

21. The composition of claim 20, further comprising at least one reactive diluent.

22. The composition of claim 20, further comprising a visible light photoinitiator.

23. A composition comprising:
(a) at least one (meth)acrylate;
(b) pentaerythritol tetrakis(3-mercaptopropionate); and
(c) an organic acid present in amounts of about 0.1% to about 5% by weight of said composition.

24. The composition of claim 23, further comprising at least one reactive diluent.

25. The composition of claim 23, further comprising a visible light photoinitiator.

26. (canceled)

27. A method of improving the liquid stability of a composition, comprising the steps of:
(a) providing a composition comprising:
(i) at least one (meth)acrylate;
(ii) at least one thiol component present in an amount sufficient to effect surface cure; and
(iii) at least one curing initiator; and
(b) adding at least one organic acid in a stabilizing amount to said composition to promote the liquid stability thereof.

28-29. (canceled)

30. A composition comprising:
(a) at least one curable component selected from the group consisting of a (meth)acrylate, vinyl ether, alkenyl ether and combinations thereof;
(b) a reactive diluent comprising at least one vinyl ether or 1-alkenyl ether group and at least one (meth)acrylate group;
(c) a thiol component; and
(d) a stabilizer selected from the group consisting of an organic acid, a hemiacetal ester derivative of an organic acid, a phenol acetal and combinations thereof.

31. The composition of claim 30, wherein said organic acid has a pKₐ of about 1.5 to about 11.5.

32. The composition of claim 30, wherein said organic acid is selected from the group consisting of: (meth)acrylic acid; maleic acid; fumaric acid; cinnamic acid; cyanoacetic acid; barbituric acid; 1,3-dimethylbarbituric acid; malonic acid; methylmalonic acid; mono-ethyl malonate; 2-acetylcyclohexanone; ethyl cyanoacetate; acetylacetone; acetoacetic acid; ethyl acetoacetate; dihydroresorcinol; 1,3-ketones; 1,3,5-triketones; β-ketoesters; ascorbic acid; phenolic compounds; pyruvic acid; mono-ethyl fumarate; mono-butyl maleate; mono-2-(methacryloyloxy)ethyl maleate; and combinations thereof.

33. (canceled)

34. The composition of claim 30, wherein said hemiacetal ester is a derivative of an organic acid selected from the group consisting of: (meth)acrylic acid; β-carboxyethyl acrylate; maleic acid; fumaric acid; cinnamic acid; and cyanoacrylic acid.

35. (canceled)

36. The composition of claim 30, wherein said curable component is selected from the group consisting of a polyurethane oligomer, a polyurethane block copolymer comprising at least one hard segment and at least one soft segment and combinations thereof.

37. The composition of claim 36, wherein said polyurethane block copolymer further comprises at least two ends, said first end being terminated with a first vinyl ether group and said second end being terminated with a second vinyl ether group.

38. The composition of claim 30, wherein said curable component is present in amounts of about 20% to about 95% by weight of said composition.

39. The composition of claim 30, wherein said thiol component is selected from the group consisting of pentaerythritol tetrakis(3-mercaptopropionate), ethoxylated pentaerythritol tetrakis(3-mercaptopropionate), pentaerythritol tetrakis(2-mercaptoacetate), tripentaerythritol octakis(thioglycollate), dipentaerythritol hexakis(thioglycollate), mercapto-propionate and acetate functional oligomers and combinations thereof.

40. The composition of claim 30, wherein said thiol component is present in amounts of about 0.25% to about 10% by weight of said composition.

41-45. (canceled)

46. A method of improving the liquid stability of a composition, comprising the steps of:
(a) providing a composition comprising:
(i) at least one curable component selected from the group consisting of a (meth)acrylate, vinyl ether, alkenyl ether and combinations thereof;
(ii) a reactive diluent comprising at least one vinyl ether or 1-alkenyl ether group and at least one (meth)acrylate group;
(iii) at least one thiol component present in an amount sufficient to effect surface cure; and
(iv) at least one curing initiator; and
(b) adding at least one stabilizer selected from the group consisting of an organic acid, a hemiacetal ester derivative of an organic acid, a phenol acetal and combinations thereof to said composition to promote the liquid stability thereof.
